(19) United States
(12) Patent Application Publication
(10) Pub. No.: US 2026/0110316 A1
(43) Pub. Date: Apr. 23, 2026

(54) MULTI-PIECE ADJUSTABLE CLIP FOR SECURING PROTECTIVE MESH TO A SOLAR PANEL

(71) Applicant: Polo Epo Enterprise, Khulna (BD)

(72) Inventor: Tapas Chandra Paul, Khulna (BD)

(21) Appl. No.: 19/362,151

(22) Filed: Oct. 17, 2025

Related U.S. Application Data
(60) Provisional application No. 63/708,338, filed on Oct. 17, 2024.

(51) Int. Cl. F16B 2/22; H02S 20/23

(52) U.S. Cl. CPC F16B 2/22; H02S 20/23

(57) ABSTRACT

An adjustable clip for securing a protective mesh to a solar panel is disclosed. The clip includes a main body having a curved profile configured to partially encircle a wire of the protective mesh and engage the edge of a solar panel frame. One or more insertable heads are slideably coupled to the main body to vary the gripping dimension of the clip, allowing it to accommodate different panel frame thicknesses and mesh gauges. The inner surface of the main body includes gripping protrusions and stabilizers that distribute load evenly, prevent slippage, and enhance structural rigidity. The clip may be formed from polytetrafluoroethylene (PTFE), other high-performance polymers, metallic materials, or fiber-reinforced composites such as carbon-or glass-fiber-reinforced polymers. The adjustable configuration provides a durable, reusable, and universally compatible fastening solution for securing protective mesh to a variety of solar panel installations.

### CROSS-REFERENCE TO RELATED APPLICATIONS

This application claims the benefit of, and priority to U.S. provisional application 63/708,338 titled, “MULTI-PIECE ADJUSTABLE CLIP FOR SECURING PROTECTIVE MESH TO A SOLAR PANEL” filed on Oct. 17, 2024, the entire specification of which is incorporated herein by reference.

### BACKGROUND OF THE INVENTION

### Field of the Art

The disclosure relates to the field of attachment clips for protective barriers for solar panels for safeguarding solar installations against wildlife and debris.

### Discussion of the State of the Art

Solar panels are devices that convert sunlight into electricity and play a crucial role in renewable energy production. They're typically installed on rooftops or in large ground-mounted arrays. While durable, solar panels can be vulnerable to various environmental factors, including damage from all wildlife, particularly rodents like rats, mice, and squirrels. The space between solar panels and the roof or ground provides shelter for rodents. Rodents may chew on wires and cables, causing electrical issues or costly equipment failure that require replacement. Further, nesting under the panel may result in overheating of the solar panels. Damages created by rodents can lead to reduced energy output, system downtime, and costly repairs.

To protect the solar panels from rodents, critter guards or mesh barriers are placed around the perimeter of the solar panel arrays. Solar panel wire and screen protectors typically use some type of fasteners. Example of fasteners may include snap-on clip, spring clip, z-clip and brackets. A snap-on clip made of plastic or metal clips directly onto the edges of the solar panels. Spring clips made of spring steel provide the required tension to hold the screening in place. Z-clips or L-brackets may also be used and are metal clips that attach to the frame of the solar panel and provide an edge for the screen to attach to. In some cases, cable ties/zip ties may be used to secure screening to the panel frame or mounting structure. These fasteners require expertise to install and the time for installation is high. Further, this variety of clip designs across manufacturers makes it challenging for installers to maintain a versatile inventory.

Furthermore, there are fasteners that are designed to work with specific types of solar panel models and specific sizes. These clips are generally designed to support common solar panel dimensions (for example, length-typically 165-170 cm, width-typically 99-101 cm, and depth-typically 35-46 mm). However, these dimensions may vary between different manufacturers and in some cases vary within models of the same manufacturer. Further, as they are mostly designed to work with a range of panel dimensions, they may not support panels with different designs or dimensions.

Hence there is a need in the art for a universal fastener that is adjustable to different types of solar panel designs and/or dimensions.

### SUMMARY OF THE INVENTION

Accordingly, the inventor has conceived and reduced to practice, in a preferred embodiment of the invention, an adjustable clip for securing a protective mesh to a solar panel that addresses different styles of solar panels accommodating different dimensions.

According to a preferred embodiment of the invention, a multi-piece adjustable clip is provided for securing a protective mesh or screen to the frame of a solar panel. The clip is designed to accommodate variations in solar panel frame thickness, mesh gauge, and installation geometry, thereby providing a universal attachment solution suitable for a wide range of solar panel types and manufacturers.

The adjustable clip includes a main body having a curved, hook-like profile that partially encircles a wire of the protective mesh and engages the outer edge of the solar panel frame. One or more insertable heads are slideably engaged with the main body to vary the gripping dimension between opposing legs of the clip. The insertable heads interlock with the main body through a series of notches and gripping protrusions, allowing the user to adjust the clip in discrete or continuous increments. This configuration enables the clip to securely retain mesh materials of differing thicknesses and conform to varying solar panel frame geometries without requiring tools or permanent fasteners.

The inner surface of the main body may include a series of gripping protrusions and stabilizers that distribute load evenly across the mesh wire, prevent slippage, and reinforce the structural integrity of the clip during installation. This arrangement allows the clip to maintain a secure attachment under environmental stresses such as wind, vibration, and thermal expansion while minimizing localized stress on the solar panel frame.

In preferred embodiments, the clip is formed from polytetrafluoroethylene (PTFE) for its superior ultraviolet resistance, low friction properties, and long-term weatherability. Alternative embodiments may employ other high-performance polymers, metallic materials, or fiber-reinforced composites such as carbon-fiber-reinforced or glass-fiber-reinforced polymers. Together, these features provide a durable, adjustable, and universally compatible fastening solution for securing protective mesh to solar panel installations.

The invention improves the reliability of solar panel pest-control systems by providing an adaptive fastening mechanism that enables faster installation of protective mesh, minimizes inventory variation across panel models, and maintains consistent clamping force and mesh retention under prolonged environmental exposure. The adjustable clip is suitable for use in commercial and residential solar panel installations for pest-control and debris-mitigation applications and for other environments.

### BRIEF DESCRIPTION OF THE DRAWING FIGURES

The accompanying drawings illustrate several embodiments of the invention and, together with the description, serve to explain the principles of the invention according to the embodiments. It will be appreciated by one skilled in the art that the particular embodiments illustrated in the drawings are merely exemplary and are not to be considered as limiting of the scope of the invention or the claims herein in any way.

FIG. 1 is an end-view of an assembled adjustable clip, according to an embodiment of the invention.

FIG. 2 is the main body of the adjustable clip, according to an embodiment of the invention.

FIGS. 3A and 3B are the perspective front-side view and back-side view of the adjustable head, according to an embodiment of the invention.

FIG. 4A is a side view of an assembled adjustable clip attached with a protective mesh, according to an embodiment of the invention.

FIG. 4B is a perspective view of an assembled adjustable clip with dual adjustable heads to accommodate solar panel width, according to an embodiment of the invention.

FIG. 5A-5B are dimensional schematic views of the adjustable clip showing representative groove and spacing dimensions, according to an embodiment of the invention.

FIG. 6A-6C are dimensional schematic views of the insertable head according to an embodiment of the invention.

### DETAILED DESCRIPTION

One or more different inventions may be described in the present application. Further, for one or more of the inventions described herein, numerous alternative embodiments may be described; it should be appreciated that these are presented for illustrative purposes only and are not limiting of the inventions contained herein or the claims presented herein in any way. One or more of the inventions may be widely applicable to numerous embodiments, as may be readily apparent from the disclosure. In general, embodiments are described in sufficient detail to enable those skilled in the art to practice one or more of the inventions, and it should be appreciated that other embodiments may be utilized and that structural, logical, software, electrical and other changes may be made without departing from the scope of the particular inventions. Accordingly, one skilled in the art will recognize that one or more of the inventions may be practiced with various modifications and alterations. Particular features of one or more of the inventions described herein may be described with reference to one or more particular embodiments or figures that form a part of the present disclosure, and in which are shown, by way of illustration, specific embodiments of one or more of the inventions. It should be appreciated, however, that such features are not limited to usage in the one or more particular embodiments or figures with reference to which they are described. The present disclosure is neither a literal description of all embodiments of one or more of the inventions nor a listing of features of one or more of the inventions that must be present in all embodiments.

Headings of sections provided in this patent application and the title of this patent application are for convenience only and are not to be taken as limiting the disclosure in any way.

Devices that are in communication with each other need not be in continuous communication with each other, unless expressly specified otherwise. In addition, devices that are in communication with each other may communicate directly or indirectly through one or more communication means or intermediaries, logical or physical.

A description of an embodiment with several components in communication with each other does not imply that all such components are required. To the contrary, a variety of optional components may be described to illustrate a wide variety of possible embodiments of one or more of the inventions and in order to more fully illustrate one or more aspects of the inventions. Some steps may be performed simultaneously despite being described or implied as occurring non-simultaneously (e.g., because one step is described after the other step). Moreover, the illustration of a process by its depiction in a drawing does not imply that the illustrated process is exclusive of other variations and modifications thereto, does not imply that the illustrated process or any of its steps are necessary to one or more of the invention(s), and does not imply that the illustrated process is preferred. Also, steps are generally described once per embodiment, but this does not mean they must occur once, or that they may only occur once each time a process, method, or algorithm is carried out or executed. Some steps may be omitted in some embodiments or some occurrences, or some steps may be executed more than once in a given embodiment or occurrence.

When a single device or article is described herein, it will be readily apparent that more than one device or article may be used in place of a single device or article. Similarly, where more than one device or article is described herein, it will be readily apparent that a single device or article may be used in place of the more than one device or article.

The functionality or the features of a device may be alternatively embodied by one or more other devices that are not explicitly described as having such functionality or features. Thus, other embodiments of one or more of the inventions need not include the device itself.

Techniques and mechanisms described or referenced herein will sometimes be described in singular form for clarity. However, it should be appreciated that particular embodiments may include multiple iterations of a technique or multiple instantiations of a mechanism unless noted otherwise. Process descriptions or blocks in figures should be understood as representing modules, segments, or portions of code which include one or more executable instructions for implementing specific logical functions or steps in the process. Alternate implementations are included within the scope of embodiments of the present invention in which, for example, functions may be executed out of order from that shown or discussed, including substantially concurrently or in reverse order, depending on the functionality involved, as would be understood by those having ordinary skill in the art.

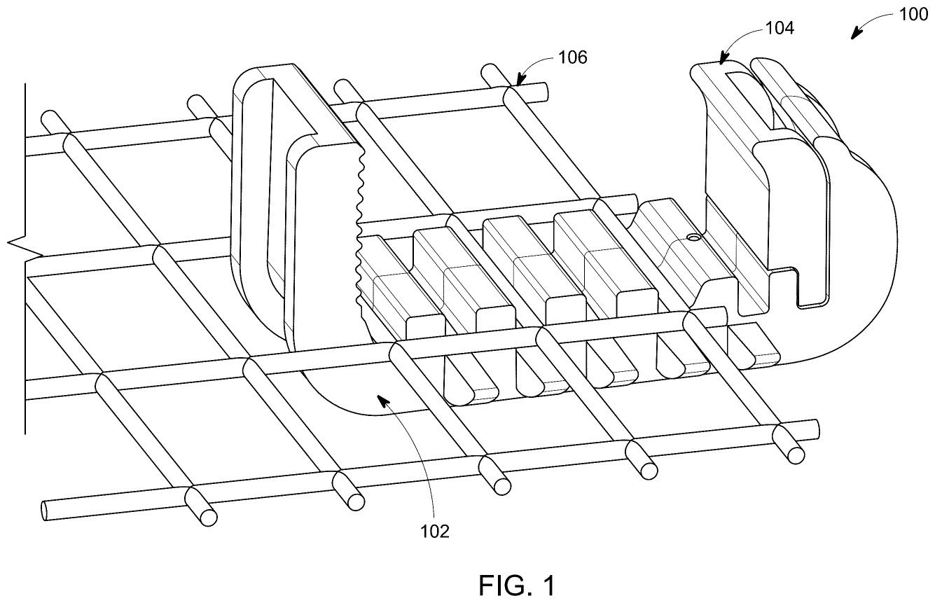

FIG. 1 is an end-view of an assembled adjustable clip 100, according to an embodiment of the invention. The assembled adjustable clip 100 is a multi-piece clip with a main body 102 and an insertable head 104. The main body 102 of adjustable clip 100 has a curved, hook-like shape that is designed to wrap around a protective mesh 106 and grip a solar panel (not shown) on which protective mesh 106 protection is installed and is operable to accommodate one or more insertable heads 104. The gray grid structure in FIG. 1 represents protective mesh 106 to which the clip would attach. Insertable head 104 is a separate piece that is operable to be slideably attached to main body 102. A single insertable head 104 is shown in FIG. 1 and it allows assembled adjustable clip 100 to accommodate a specific solar panel frame thickness. It should be appreciated by one with ordinary skill in the art that more than one insertable head 104 may be attached to decrease the width of the opening to universally accommodate solar panels of different sizes. Main body 102 of adjustable clip 100 and insertable head 104 may be made of high-quality, UV-resistant materials that can withstand environmental stresses. In an embodiment, main body 102 and insertable head 104 may be integrally formed as a single piece using a multi-material molding process. In an embodiment, main body 102 may be formed from a rigid material and insertable head 104 may be formed from a more flexible material. In one embodiment, main body 102 and insertable head 104 may be manufactured from high-quality plastics. In a preferred embodiment, materials used herein are resistant to corrosion.

In a preferred embodiment, the main body 102 and insertable head 104 are formed from polytetrafluoroethylene (PTFE), selected for its superior ultraviolet (UV) resistance, corrosion resistance, low surface energy, and temperature stability, all of which make it ideally suited for outdoor use in solar installations. PTFE's inherent lubricity facilitates smooth engagement between the insertable head 104 and the main body 102, minimizing wear and insertion force. PTFE components may be compression-molded, isostatically molded, or paste-extruded and sintered, followed by secondary machining to achieve groove tolerances and surface finish.

Weatherability may be enhanced with carbon-black or HALS (hindered amine light stabilizers) additives.

In alternative embodiments, the components may be formed from other high-performance polymers such as polypropylene (PP), polyethylene terephthalate (PET), polycarbonate (PC), nylon (PA6, PA66), or acetal (POM), optionally with glass fiber or mineral reinforcement for improved stiffness and heat resistance. Such materials are typically processed by injection molding or extrusion, depending on production volume and geometry. In another embodiment, multi-material molding may be used, wherein the main body 102 is molded from a rigid polymer (for example, glass-filled PA66) and the insertable head 104 or gripping regions are overmolded with a thermoplastic elastomer (TPE or TPU) to increase compliance and mesh retention.

In yet another embodiment, the main body 102 and insertable head 104 may be formed from fiber-reinforced composites, such as carbon-fiber-reinforced polymer (CFRP) or glass-fiber-reinforced polymer (GFRP). These materials provide exceptional mechanical stiffness, dimensional stability, and resistance to creep under sustained load, making them suitable for high-temperature or high-vibration environments. CFRP components may be produced via compression molding, resin transfer molding (RTM), or pultrusion, with woven or unidirectional layups selected to align the fibers along the stress paths of the clip geometry.

In still other embodiments, metallic materials such as stainless steel, galvanized steel, or aluminum alloys may be used. Metal variants may be stamped, laser-cut, or CNC-machined, followed by bending/forming, deburring, and surface finishing operations such as passivation, anodizing, or powder coating to enhance corrosion and UV resistance.

Regardless of the material selected, surface textures or micro-features may be molded or machined into the gripping protrusions 202 to control frictional engagement, and durometer or elastic modulus of elastomeric portions may be tuned to balance ease of installation with secure retention. These material and manufacturing combinations enable the adjustable clip 100 to achieve long-term environmental durability, mechanical strength, and compatibility with a wide variety of solar panel and mesh configurations.

The clip may be produced by any conventional forming, molding, or machining process suitable for the selected material, including additive manufacturing methods for prototype or low-volume production.

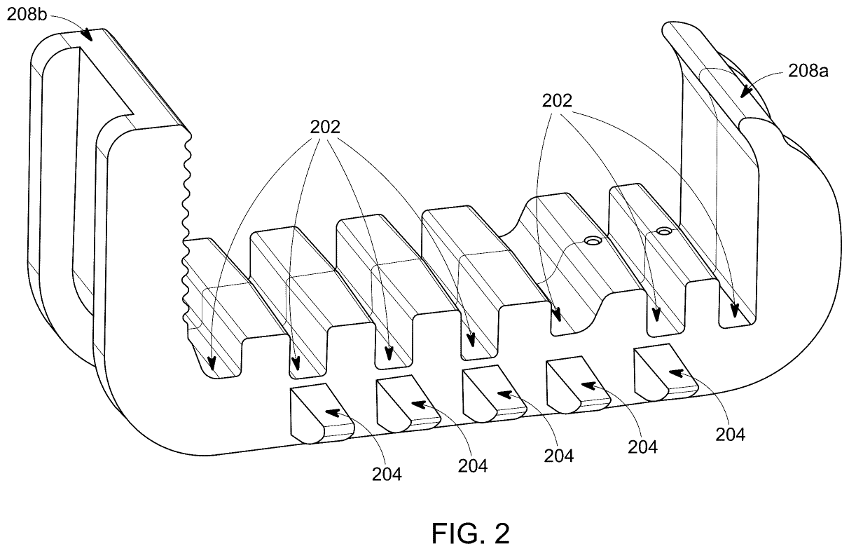

Referring now to FIG. 2 main body 102 of adjustable clip 100, according to an embodiment of the invention. The inner surface of main body 102 may include a plurality of gripping protrusions 202 to engage with the wire of the protective mesh 106. The inner part of main body 102 features a series of small, protrusions 202 along a longitudinal axis of the main body 102 and may be designed to provide a secure grip on protective mesh 106 and to prevent slippage of wire. The series of protrusions 202 on the inner surface of adjustable clip 100 provides a strong, distributed grip.

The main body 102 comprises a plurality of gripping protrusions 202 disposed along its inner surface to engage with the wire of the protective mesh 106. Between adjacent gripping protrusions 202 are a series of stabilizers 204 that extend longitudinally along the wall of the main body 102. Stabilizers 204 provide structural reinforcement to resist flexing during installation, maintain alignment between the gripping protrusions 202, and guide the insertable head 104 during sliding engagement. Together, the gripping protrusions 202 and stabilizers 204 distribute load evenly and enhance the secure retention of the mesh wire, improving both stability and durability of the clip.

In an embodiment, main body 102 of adjustable clip 100 may include two legs 208A and 208B, with one of the legs being longer (208B) than the other (208A) for a more secure fixing than conventional clips. The distance between the two legs 208A and 208B may be referred to as the gripping dimension 206. This gripping dimension 206 can be varied using one or more insertable heads 104 (referring to FIG. 1) to match the thickness of the solar panel on which the protective mesh 106 is to be installed.

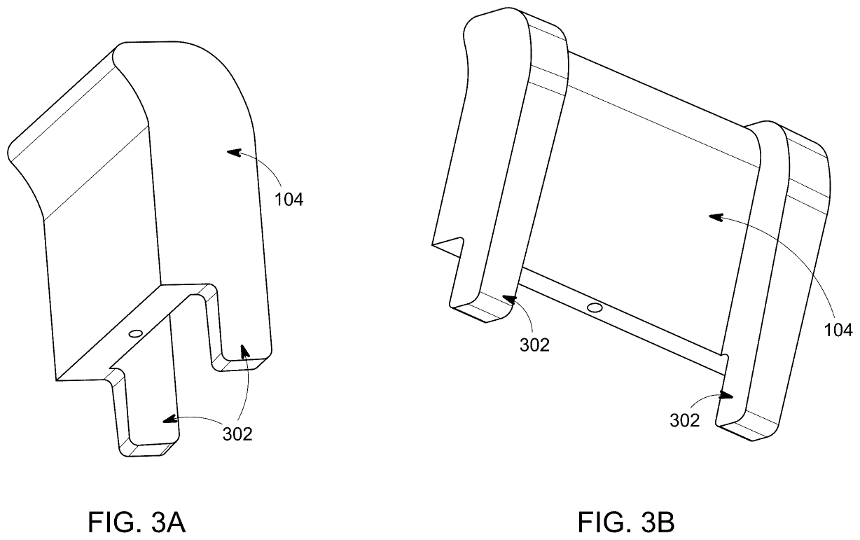

FIGS. 3A and 3B are perspective front-side view and back-side view of the insertable head 104, according to a preferred embodiment of the invention. According to the embodiment, insertable head 104 is a separate piece from main body 102 and one or more adjustable heads 104 may be used for varying gripping dimension 206 of adjustable clip 100 to accommodate different solar panel frame thickness. Adjustable heads 104 may include a series of notches 302 that are configured to slideably engage with the gripping protrusions 202 in main body 102.

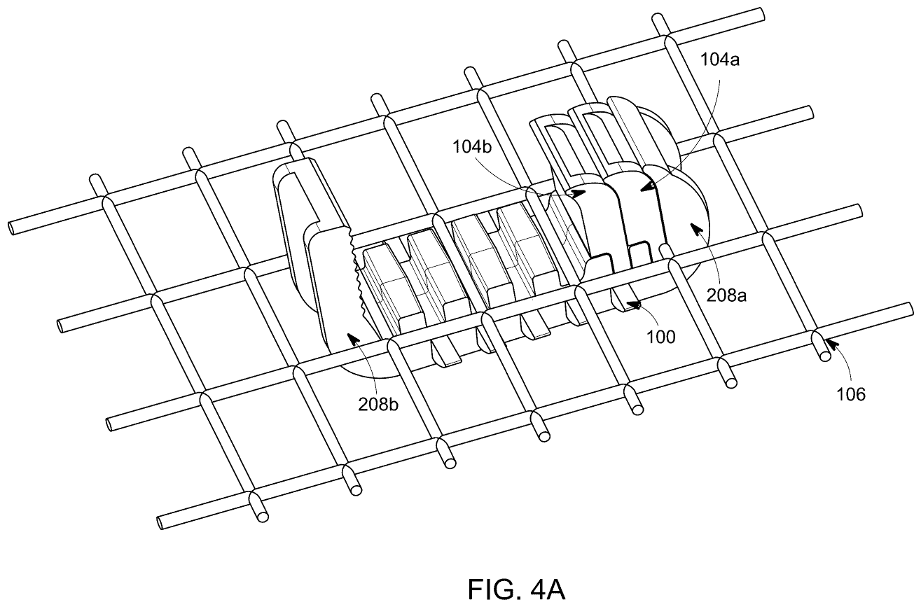

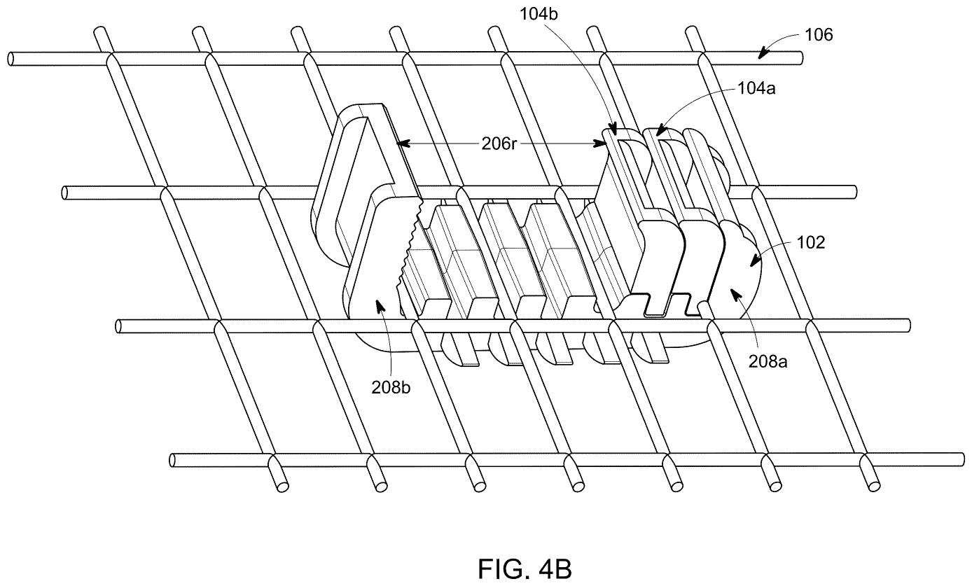

FIG. 4A is a side view of an assembled adjustable clip 100 attached with a protective mesh 106, according to an embodiment of the invention. According to the embodiment, there are two adjustable heads 104A and 104B that are connected to the main body 102 to vary the gripping dimension of adjustable clip 100. This adjustable clip 100 is then attached to the frame of the solar panel. The combination of the curved shape of main body 102 and gripping protrusions 202 advantageously provide a more secure attachment over existing snap-on clips known in the art, and adjustable heads 104 allow adjustable clip 100 to be used for a wide range of panel and mesh types providing a single unit to service solar panels of differing sizes.

FIG. 4B is a perspective view of an assembled adjustable clip 100 with dual adjustable heads 104A and 104B to accommodate solar panel width, according to an embodiment of the invention. There are two adjustable heads 104A and 104B that are connected to the main body 102 creating a reduced gripping dimension 206R for adjustable clip 100 to accommodate solar panel width. In an embodiment, main body 102 and the adjustable heads 104A and 104B are configured to cooperatively secure protective mesh 106 to a frame of the solar panel when the adjustable clip 100 is in a closed position. Assembled adjustable clip 100 can easily be snapped to the solar panel for easy installation without the use of special tools. The curved design of the main body 102 and distributed gripping protrusions 202 could help spread the load more evenly, potentially reducing stress on the panel frame. The design of adjustable clip 100 as shown in FIGS. 1-4 may allow attachment from multiple angles to accommodate different panel orientations or mesh configurations.

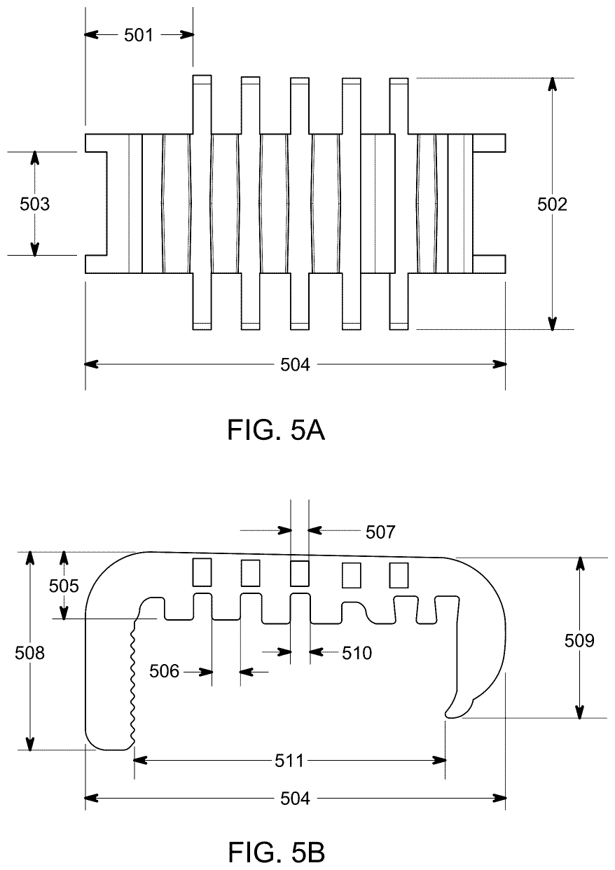

FIGS. 5A and 5B are dimensional schematic views of the main body 102 of the adjustable clip showing representative groove and spacing dimensions, according to an embodiment of the invention. The dimensions provided are exemplary and may vary depending on material selection, solar panel frame thickness, and mesh gauge.

In the illustrated embodiment, the main body 102 has an overall length 504 that may range from 41.0 mm to 61.5 mm, with a preferred length of 51 mm. Width 502 may range from 24.8 mm to 37.2 mm, with a preferred width of 31.0 mm. Groove 503 may range from 9.8 mm to 14.6 mm, with a preferred wall thickness of 12.2 mm.

Stabilizer spacing 507 for each stabilizer 204 may range from 2.7 mm to 4.1 mm, with a preferred width of 3.4 mm, enabling use with different mesh wire gauges. Each groove spacer 506 may range from 2.71 mm to 4.05 mm, with a preferred width of 3.38 mm. The body height 505 defining the height of the main body 102 may range from 6.62 mm to 9.93 mm, with a preferred radius of 8.28 mm, enabling the clip to wrap securely around both protective mesh 106 and the frame of the solar panel without excessive compression or deformation. Height 508 represents the vertical dimension of the inner gripping surface extending from the lower edge of main body 102 toward the curved hook region. Height 508 may range from 17.6 mm to 26.4 mm, with a preferred height of 22.0 mm. This height contributes to the clip's capacity to retain protective mesh 106 under compressive loading while maintaining sufficient clearance for easy installation. Channel 510 defines the insertion region where the wire of protective mesh 106 may be received and retained within main body 102. Channel 510 width may range from 1.98 mm to 2.98 mm, with a preferred width of 2.48 mm. This channel serves as the primary interface between the mesh and the clip, allowing the mesh wire to be securely seated during installation while enabling controlled flexing of the surrounding wall sections for snap-fit engagement with the solar panel frame. Height 509 corresponds to the total vertical extent of the curved hook section of main body 102 measured from the lower gripping surface to the upper inner surface of the hook. Height 509 may range from 14.0 mm to 21.0 mm, with a preferred height of 17.5 mm. This dimension influences the overall depth of engagement around the solar panel frame and provides a balance between clamping force and ease of release. Internal length 511 defines the longitudinal distance between the two sides of the unit defined by height 508 and height 509. Internal length 511 may range from 30.3 mm to 45.5 mm, with a preferred length of 37.9 mm. This internal length establishes the clearance space for the solar panel frame lip and the protective mesh wire, ensuring that both are securely captured when adjustable clip 100 is in position.

The width between opposing legs 208A and 208B, referred to as the gripping dimension 211, and may be adjusted using one or more insertable heads 104 to accommodate a range of solar panel frame thicknesses.

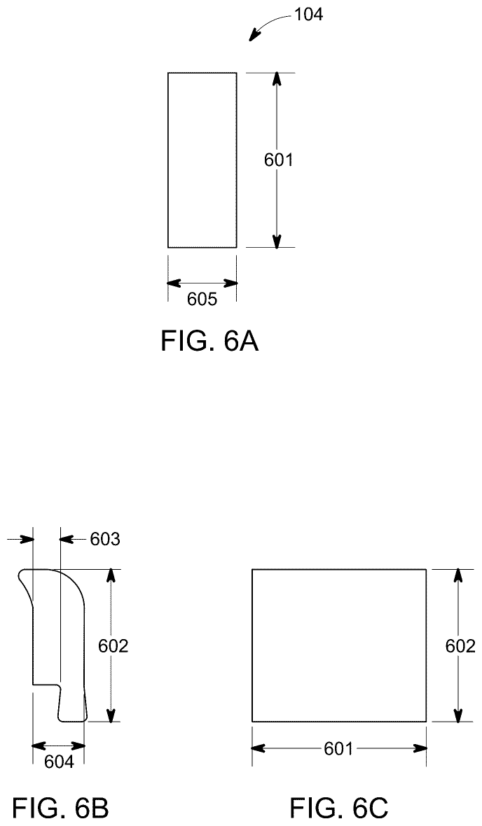

FIG. 6A-6C are dimensional schematic views of insertable head 104 according to an embodiment of the invention. The figures illustrate representative measurements that define the geometry and engagement interface of insertable head 104 with main body 102. Dimensional features 601-605 correspond to parameters that determine the sliding and locking fit of insertable head 104 within a channel of main body 102. Width 601 represents the overall lateral dimension of insertable head 104. FIG. 6A is a top view showing the overall width and depth of insertable head 104. FIG. 6B is a side view illustrating the overall, shape, height and depth relationship of the insertable head and engagement sections of the insertable head that interlock with main body 102. FIG. 6C is a back view showing the width and height of insertable head 104.

Width 601 may range from 13.6 mm to 20.4 mm, with a preferred width of 17.0 mm. Height 602 defines the vertical dimension of insertable head 104 extending from the lower contact surface to the upper alignment surface. Height 602 may range from 12.0 mm to 18.0 mm, with a preferred height of 15.0 mm. Front depth 603 defines the forward projecting thickness of the head portion that engages with the interior of main body 102. Front depth 603 may range from 2.1 mm to 3.1 mm, with a preferred depth of 2.6 mm. Width 604 defines the lateral thickness of the retention section of insertable head 104 that interlocks with the corresponding recess in main body 102. Width 604 may range from 4.0 mm to 6.0 mm, with a preferred width of 5.0 mm. Depth 605 defines the longitudinal dimension from the front face to the rear face of insertable head 104. Depth 605 may range from 5.3 mm to 7.9 mm, with a preferred depth of 6.6 mm.

These dimensional parameters collectively define the structural geometry of insertable head 104, providing the proportional relationships required for reliable sliding engagement, secure retention, and repeatable adjustment within adjustable clip 100. The ranges may vary depending on the material composition and manufacturing process while maintaining compatibility with main body 102. All measurements are in millimeters unless otherwise indicated. These tolerances of approximately ±20 percent allow for manufacturing flexibility while maintaining compatibility with various solar panel frame profiles. The dimensional parameters shown in FIGS. 5A-B, and FIGS. 6A-C may be scaled proportionally for smaller or larger versions of the main body 102 while maintaining the same geometric relationships, ensuring an optimal balance between flexibility, gripping, and application.

Together, these features define the structural geometry of main body 102 to provide resilient gripping action, repeatable engagement over multiple installation cycles, and reliable retention of protective mesh 106 under varying environmental and loading conditions.

The skilled person will be aware of a range of possible modifications of the various embodiments described above. Accordingly, the present invention is defined by the claims and their equivalents.

What is claimed is:

1. An adjustable clip for securing a protective mesh to a solar panel, the clip comprising:
a main body having a curved profile configured to partially encircle a wire of the protective mesh and engage an edge portion of a frame of the solar panel;
a plurality of gripping protrusions disposed along an inner surface of the main body to engage the protective mesh; and
one or more insertable heads slideably coupled to the main body, the one or more insertable heads being positionable to vary a gripping dimension between opposing legs of the main body to accommodate solar panel frames of different thicknesses.

2. The adjustable clip of claim 1, wherein the one or more insertable heads include a plurality of notches configured to interlock with the gripping protrusions of the main body to provide discrete adjustment positions.

3. The adjustable clip of claim 1, wherein the one or more insertable heads are configured to slide continuously along a longitudinal axis of the main body to provide adjustment of the gripping dimension.

4. The adjustable clip of claim 1, wherein the inner surface of the main body further comprises a plurality of stabilizers positioned between the gripping protrusions, the stabilizers providing structural reinforcement and alignment for the insertable head.

5. The adjustable clip of claim 1, wherein the main body comprises a first leg and a second leg extending from the curved profile, one of the legs being longer than the other to enhance grip and stability during installation.

6. The adjustable clip of claim 1, wherein the main body and the one or more insertable heads are formed from polytetrafluoroethylene (PTFE).

7. The adjustable clip of claim 6, wherein the PTFE is compression-molded, isostatically molded, or paste-extruded and sintered.

8. The adjustable clip of claim 1, wherein the main body and the one or more insertable heads are formed from a polymer selected from the group consisting of polypropylene (PP), polyethylene terephthalate (PET), polycarbonate (PC), nylon (PA6, PA66), and acetal (POM).

9. The adjustable clip of claim 1, wherein the main body and the one or more insertable heads are formed from a fiber-reinforced composite selected from the group consisting of carbon-fiber-reinforced polymer (CFRP) and glass-fiber-reinforced polymer (GFRP).

10. The adjustable clip of claim 1, wherein the main body and the one or more insertable heads are formed from a metallic material selected from the group consisting of stainless steel, galvanized steel, and aluminum alloy.

11. The adjustable clip of claim 1, wherein the main body is molded from a rigid material and the one or more insertable heads are overmolded with a flexible or elastomeric material to improve mesh retention.

12. The adjustable clip of claim 1, wherein the gripping protrusions and the stabilizers are distributed to provide uniform load distribution across the protective mesh.

13. The adjustable clip of claim 1, wherein the gripping dimension is adjustable in increments corresponding to a spacing between adjacent gripping protrusions.

14. The adjustable clip of claim 1, wherein the curved profile of the main body defines an angle of curvature between about 1° and about 10° relative to a longitudinal axis of the clip.

15. The adjustable clip of claim 1, wherein the main body and the one or more insertable heads are configured to snap onto the solar panel frame without the use of tools or permanent fasteners.

16. A method of securing a protective mesh to a solar panel, the method comprising:
providing an adjustable clip according to claim 1;
positioning the protective mesh adjacent to a frame of the solar panel;
inserting the protective mesh into a curved portion of a main body of the adjustable clip; adjusting one or more insertable heads of the adjustable clip to vary a gripping dimension between opposing legs of the main body to correspond to a thickness of the solar panel frame; and
engaging the adjustable clip onto the solar panel frame such that the protective mesh is retained between the clip and the frame.

17. The method of claim 16, wherein adjusting the one or more insertable heads comprises sliding the insertable heads along gripping protrusions of the main body until a desired clamping force is achieved.

18. The method of claim 16, further comprising installing a plurality of the adjustable clips around a perimeter of the solar panel array to secure the protective mesh continuously along the panel edges.

19. The method of claim 16, wherein engaging the adjustable clip comprises snapping the main body of the clip onto the solar panel frame without the use of tools or permanent fasteners.

20. The method of claim 16, further comprising periodically removing and reattaching the adjustable clip to inspect or replace the protective mesh, wherein the low-friction surfaces of the main body and insertable heads reduce wear and facilitate repeated installation.
